(19) United States
(12) Patent Application Publication
(10) Pub. No.: US 2006/0099975 A1
(43) Pub. Date: May 11, 2006

(54) Personal data assistant having a detachable voice communication device

(76) Inventor: Sarosh Vesuna, Los Altos, CA (US)

Correspondence Address: FAY KAPLUN & MARCIN, LLP, 15O BROADWAY, SUITE 702, NEW YORK, NY, 10038, US

(21) Appl. No.: 10/975,719

(22) Filed: Oct. 28, 2004

(51) Int. Cl. H04Q 7/20

(52) U.S. Cl. 455/466

(57) ABSTRACT

Described is a mobile computing arrangement which includes a body including a communication dock; a first data link port situated in the dock; a memory storing data that includes at least one telephone number; and a detachable voice communication device including a wireless transducer, a memory and a second data link port. When the device is situated in the dock, the arrangement is capable of transmitting the data to the device via the first and second ports and/or (ii) wirelessly communicating utilizing the transducer.

### BACKGROUND INFORMATION

Since the introduction of the Palm Pilot in 1996, the personal data assistant (“PDA”) has become a widely used consumer device. PDAs generally comprise a portable handheld computing device that allow users to store addresses, phone numbers, and appointments. PDAs are often designed to complement a desktop or laptop computer and therefore may allow for the synchronization of data between the two.

Even more prevalent than PDAs, cellular phones allow for mobile communication between users almost anywhere in the world. A cellular phone generally includes a radio-like device capable of receiving and transmitting data via a network of antennas situated in cells (e.g., ten square mile areas). The cells may be located anywhere around the world. Similar to PDAs, many cellular phones are capable of storing information such as phone numbers, addresses, and appointments.

Transporting both a PDA and a cellular phone may be cumbersome, and the devices often contain redundant information. Some attempts have been made to combine the functionality of a PDA with a cellular phone. However, such devices tend to be undesirably small for a PDA and undesirably large for a cellular phone.

### SUMMARY

The present relates to a mobile computing arrangement which includes a body including a communication dock; a first data link port situated in the dock; a memory storing data that includes at least one telephone number; and a detachable voice communication device including a wireless transducer, a memory and a second data link port. When the device is situated in the dock, the arrangement is capable of transmitting the data to the device via the first and second ports and/or (ii) wirelessly communicating utilizing the transducer.

### BRIEF DESCRIPTION OF THE DRAWINGS

FIG. 1 shows an exemplary embodiment of a mobile device and detachable communication device according to the present invention;

FIG. 2 shows an exemplary embodiment of a detachable communication device according to the present invention;

FIG. 3A shows a side view of the mobile device and detachable communication device in FIG. 1;

FIG. 3B shows a back view of the mobile device and detachable communication device in FIG. 1;

FIG. 4A shows a front view of another exemplary embodiment of a mobile device and detachable communication device according to the present invention;

FIG. 4B shows a side view of the exemplary embodiment of a mobile device and detachable communication device shown in FIG. 4A;

FIG. 5 shows another exemplary embodiment of a detachable communication device according to the present invention.

### DETAILED DESCRIPTION

The present invention is directed to a mobile device or personal data assistant (“PDA”) including a compact, detachable mobile communication device.

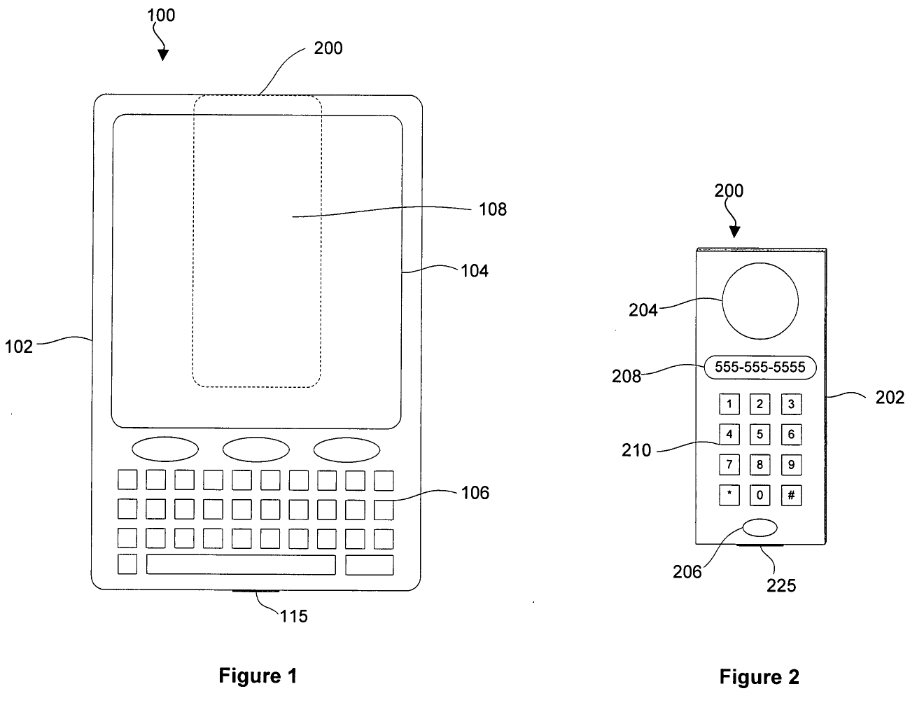

FIG. 1 shows an exemplary embodiment of a mobile device 100 according to the present invention. The mobile device 100 (e.g., mobile computing arrangement) is preferably sufficiently small for ease of portability. However, some embodiments of the mobile device 100 may be larger, e.g., a laptop computer mobile device. The mobile device 100 includes a device body 102 (e.g., body) to enclose the components of the mobile device 100. For example, the device body 102 may enclose a power source (not shown) and a memory (not shown). The power source may include one or more batteries (e.g., alkaline and/or rechargeable), or any other power source known to those of ordinary skill in the art. In some embodiments, the power source of the mobile device 100 includes a fuel cell (e.g., a hydrogen micro-fuel cell). The memory of the mobile device 100 may include, for example, any known forms of read-only memory (“ROM”) and random access memory (“RAM”). The memory may also include removable memory (e.g., a Compact Flash (“CF”) memory card or Secure Digital (“SD”) memory card).

The mobile device 100 according to the present invention is capable of storing information in the memory. For example, the memory may include addresses, phone numbers, tasks, emails, and appointments. The mobile device 100 may also store computer or document files, e.g., Microsoft Excel or Word files. The mobile device 100 includes a conventional processor (not shown) for processing the information. As one of ordinary skill in the art will understand, the information and files may be accessed, modified, and stored on the mobile device 100 via the processor and an operating system (e.g., Palm OS available from 3Com Corporation or PocketPC available from Microsoft Corporation).

The mobile device 100 may include a synchronization port 115. The synchronization port 115 may be, for example, a USB connection, a Firewire connection, a 4- or 6-pin data connection, or any other data connection known to those of skill in the art. In some embodiments, the synchronization port 115 is a wireless connection (e.g., bluetooth and/or wireless LAN connection). The mobile device 100 may send and receive data via the synchronization port 115 with, for example, a personal computer or a peripheral (e.g., a keyboard, a barcode scanner, etc.). The mobile device 100 may also receive power via the synchronization port 115. For example, an embodiment of the mobile device 100 including a rechargeable power source may be charged via a power supply in communication with the synchronization port 115.

Some embodiments of the mobile device 100 include wireless network capability. For example, the mobile device 100 may include embedded wireless capability and/or a wireless network card (e.g., a 802.11b wireless PDA network card) to send and receive data (e.g., information and/or files) via a wireless communication network.

Shown in FIG. 1, the mobile device 100 may include a display 104 allowing a user to view information. The display 104 may be, for example, a liquid crystal display (“LCD”). In addition to being an output device, the display 104 may also be an input device. For example, the display 104 may be a touch screen capable of receiving input via touch selection or handwriting recognition. Thus, as one of ordinary skill in the art will understand, a user of the mobile device 100 may view, modify, and input information via the display 104.

The mobile device 100 may, alternatively or in combination, include a keyboard 106 (e.g., a Sholes keyboard). The keyboard 106 allows for the input and modification of information in the mobile device 100. The keyboard 106 may be a physical keyboard as shown in FIG. 1, or a touch screen virtual keyboard within the display 104. The keyboard 106 may also be detachable and communicate wirelessly with the mobile device 100 or via a wired connection to the synchronization port 115. Some embodiments of the mobile device 100 may include a voice recognition system to further receive user input.

The mobile device 100 according to the present invention includes a detachable communication device 200 (e.g., a mobile phone). The detachable communication device 200 is a two-way (e.g., a full-duplex) communication device (e.g., a voice communication device). The detachable communication device 200 may be adaptable for communication on any cellular or mobile (e.g., digital) network known to those of skill in the art. For example, the detachable communication device 200 may communicate via a personal communications services (“PCS”) network, a global system for mobile communications (“GSM”) network, a wireless LAN (“WLAN”) based voice over IP network or any other wireless wide area network.

As shown in FIG. 2, the detachable communication device 200 includes a device body 202. The device body 202 may be manufactured of any sufficiently durable and lightweight material known to those in the art. The device body 202 may house, for example, a power source (not shown). The power source may include, e.g., one or more batteries (e.g., alkaline and/or rechargeable), a fuel cell (e.g., a hydrogen micro-fuel cell), or any other power source known to those of ordinary skill in the art. The detachable communication device 200 may also include a transmission processor (e.g., wireless transducer) including, for example, a digital signal processor and/or a microprocessor (not shown). In some embodiments, the transmission processor includes a digital-to-analog convertor and/or an analog-to-digital convertor.

The detachable communication device 200 may also include a speaker 204 and a microphone 206. As one of ordinary skill in the art will understand, the speaker 204 may transmit audio information received from the communication network to the user. The microphone 206 receives audio information from the user and transmits to the communication network via the transmission processor in the detachable communication device 200.

Some embodiments of the detachable communication device 200 according to the present invention include a caller display 208. The caller display 208 may display information to the user, e.g., an incoming caller's phone number. However, other embodiments do not include a caller display 208. In some other embodiments of the present invention, an incoming caller's phone number may be displayed on the display 104 of the mobile device 100.

The detachable communication device 200 may include a keypad 210. The keypad 210 is used to input a phone number and initiate communication (e.g., a phone call) via the communication network. Some embodiments of the detachable communication device 200 do not include a keypad 210 and a phone number may be received via the display 104 or keyboard 106 of the mobile device 100. Discussed in more detail below, the phone number may then be transmitted to the detachable communication device 200 wirelessly or via a data connection (e.g., a data link). In some other embodiments, a phone number may be communicated to the detachable communication device 200 by a voice recognition system.

The detachable communication device 200 according to the present invention includes a phone data link 225 (e.g., second data link port) to transfer and receive information via the mobile device 100. The phone data link 225 may be, for example, a USB connection, a Firewire connection, a 4- or 6-pin data connection, or any other data connection known to those of skill in the art. Some embodiments include a Bluetooth™ chip to wirelessly transfer and receive information via any other Bluetooth™ enabled device (e.g., the mobile device 100). The detachable communication device 200 includes a memory (not shown) to store (e.g., temporarily or permanently) information, for example, received from the mobile device 100 or the keypad 210.

The mobile device 100 includes a dock 108 to support (e.g., contain) the detachable communication device 200, including a device data link 120 (e.g., first data link port). The device data link 120 may include a data connection (e.g., USB, Firewire) compatible with the phone data link 225 of the detachable communication device 200. The detachable communication device 200, when stored within the dock 108, may exchange information with the mobile device 100 via the phone data link 225 and the device data link 120. For example, a phone number may be communicated to the mobile device 100 (e.g., via the display 104 or the keyboard 106) and transmitted to the detachable communication device 200 via the communication port 120. A user may then remove the detachable communication device 200 from the dock 108 to initiate the phone call. The detachable communication device 200 and the mobile device 100 may also share power via the data links 225/120. For example, the power source of the mobile device may provide energy to charge a rechargeable battery in the detachable communication device 200.

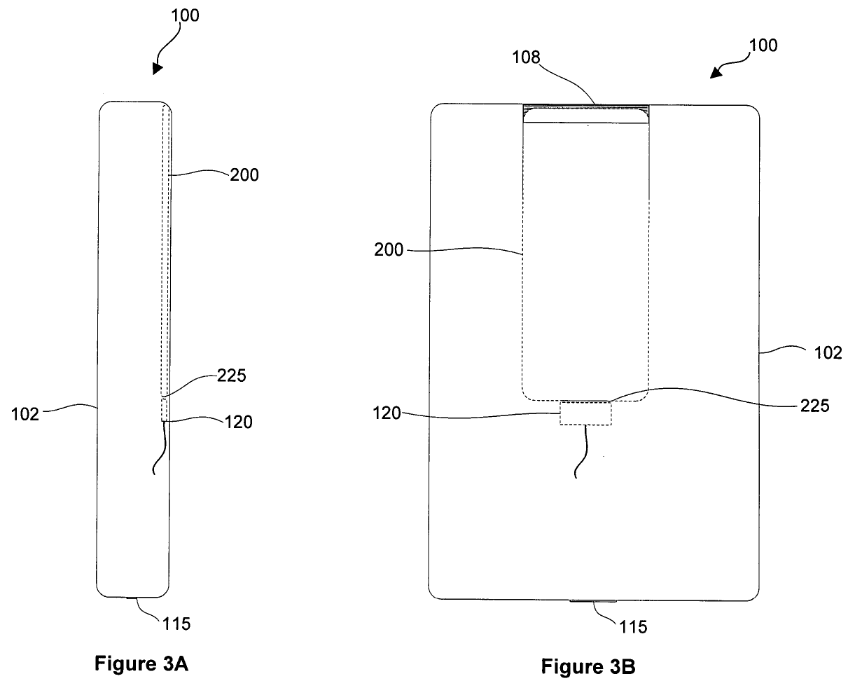

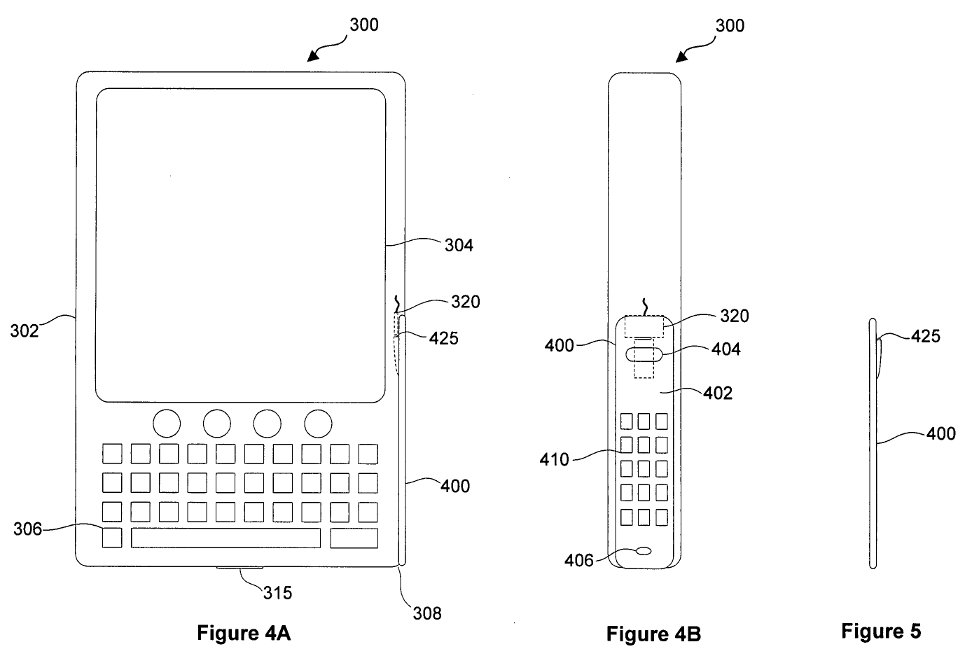

The dock 108 may include a slot in the mobile device 100 as shown in FIGS. 3A and 3B. The slot is sized to receive a substantial portion of the detachable communication device 200 within the device body 102. As shown in another embodiment in FIGS. 4A and 4B, a dock 308 may alternatively include a cradle on the exterior of a device body 302. The dock 108/308 may include a retention device (not shown) to secure the detachable communication device 200/400 in the dock 108/308. The retention device may be any releaseable locking mechanism known to those in the art.

The exemplary embodiment of the mobile device 300 shown in FIGS. 4A and 4B similarly includes a device body 302, a display 304 and optionally, a keyboard 306. The mobile device 300 includes a synchronization port 315 and a device data link 320 compatible with a phone data link 425 on a detachable communication device 400.

Shown in FIGS. 4A-4C, the detachable communication device 400 may be of any shape and size compatible with the dock 308 of the mobile device 300. In the exemplary embodiment, the detachable communication device 400 includes a device body 402, speaker 404, a microphone 406, a power source (not shown), and memory (not shown). The detachable communication device 400 may optionally include a keypad 410.

The exemplary embodiment of the detachable communication device 400 may be used to communicate via a communication network (e.g., a cellular network or wireless LAN based network). For example, a phone number may be received in the detachable communication device 400 from the mobile device 300 via connectivity between the device data link 320 in the mobile device 300 and a phone data link 425 in the detachable communication device 400. The phone number may be stored in a memory of the detachable communication device 400 and the detachable communication device 400 removed from the dock 308 to initiate the call. Alternatively, the user may initiate a call with the detachable communication device 400 remaining in the dock 308. For example, an auxiliary speaker (not shown), e.g., an earpiece or headset, may be used. In other embodiments, the detachable communication device 400 may be operated while in the dock 308, e.g., in a speaker phone configuration.

Those skilled in the art will understand that the detachable communication device 400 may serve as a wireless transducer for the mobile device 300. For example, when the detachable communication device 400 is connected to the mobile device 300, the mobile device 300 obtains access to the Internet, email, etc.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. A mobile computing arrangement, comprising:
a body including a communication dock;
a first data link port situated in the dock;
a memory storing data that includes at least one telephone number; and
a detachable voice communication device including a wireless transducer, a memory and a second data link port,
wherein when the device is situated in the dock, the arrangement is capable of at least one of (i) transmitting the data to the device via the first and second ports and (ii) wirelessly communicating utilizing the transducer.

2. The arrangement according to claim 1, wherein when the device is detached from the arrangement, the device wirelessly communicates via the transducer.

3. The arrangement according to claim 2, wherein the device wirelessly communicates via a mobile communications network.

4. The arrangement according to claim 3, wherein the mobile communications network is one of a personal communications services (“PCS”) network, a global system for mobile communications (“GSM”) network, a wireless LAN (“WLAN”) based voice over IP network and a wireless wide area network.

5. The arrangement according to claim 1, further comprising:
a power source.

6. The arrangement according to claim 5, wherein the power source includes one of a rechargeable battery and a fuel cell.

7. The arrangement according to claim 1, wherein each of the first and second data link ports includes one of a USB connection, a Firewire connection and a wireless connection.

8. The arrangement according to claim 7, wherein the wireless connection is a Bluetooth connection.

9. The arrangement according to claim 1, wherein the memory includes removable memory including one of a compact flash memory and a secure digital memory.

10. The arrangement according to claim 1, wherein the data includes at least one of an address, a document file and an email.

11. The arrangement according to claim 1, further comprising:
a synchronization port capable of sending and receiving the data via a computer.

12. The arrangement according to claim 11, wherein the synchronization port includes a wireless connection.

13. The arrangement according to claim 1, further comprising:
an input arrangement capable of receiving data input from a user.

14. The arrangement according to claim 13, wherein the input arrangement includes at least one of a touch screen display, a keyboard and a voice recognition system.

15. The arrangement according to claim 1, wherein the detachable voice communication device includes a speaker and a microphone.

16. The arrangement according to claim 1, wherein the detachable voice communication device includes a numerical keypad.

17. The arrangement according to claim 1, wherein the detachable voice communication device includes a caller display displaying wireless communication information to a user.

18. The arrangement according to claim 7, wherein the wireless connection is a short range wireless communication connection.

19. The arrangement according to claim 5, wherein the power source recharges a further power source of the device when the device is situated in the dock.
